(19) United States
(12) Patent Application Publication
(10) Pub. No.: US 2011/0011614 A1
(43) Pub. Date: Jan. 20, 2011

(54) TREATED ELECTRICAL CABLE

(75) Inventors: Clifford Eugene Brown, JR., Apollo Beach, FL (US); Robert Pereira, Rochester, MA (US)

Correspondence Address: Tyco International Management Corp., 9 Roszel Road, Princeton, NJ, 08540, US

(73) Assignee: WPFY, INC., Wilmington, DE (US)

(21) Appl. No.: 12/505,675

(22) Filed: Jul. 20, 2009

(51) Int. Cl. H01B 9/02; H01R 43/00

(52) U.S. Cl. 174/107; 29/825

(57) ABSTRACT

Improved electrical cables employ a protective material thereon for antimicrobial prevention. The electrical cable is formed by a metallic strip helically wound with interlocking edges to define an armor having an inner hollow area within which is housed a plurality of electrical conductors. The armor is treated with a coating which may be used for corrosion protection. The coating is treated with an antimicrobial and/or antifungal additive inhibiting the proliferating or these microorganisms on the cable.

### BACKGROUND OF THE INVENTION

1. Field of the Invention

Embodiments of the invention relate to the field of electrical cable. More particularly, the present invention relates to improved cables employing a protective material thereon for antimicrobial and/or antifungal prevention.

2. Discussion of Related Art

In the construction industry, electrical wires are often run through various structures to safely deliver power to and from a panel and then onto different areas of a building or structure. Generally, conduit refers to a product in which the electrical conductors are pulled through a protective metal armor that may be flexible or rigid after the conduit is installed in a desired location. Conversely, cable refers to a metallic or polymeric flexible armor which is applied around electrical conductors during manufacture. Types of cable include Armored cable (“AC”) and Metal-Clad (“MC”) cable each of which provide electrical wiring for various types of construction applications. Generally, Type AC and Type MC cable have different internal constructions and performance characteristics and are governed by different standards. For example, Type MC cable is governed by the National Electric Code (NEC®) Article 330 and Type AC cable is governed by NEC® Article 320. Basically, these cables house electrical conductors within a metal armor. The metal armor may be flexible enabling the cable to bend while protecting the conductors against external damage during and after installation. The armor which houses the electrical conductors may be made from steel, aluminum or other materials. The metal armor is formed from steel, aluminum or other metallic materials, which are helically wrapped to define a series of interlocked “S” shaped sections along a longitudinal length of the cable to form the metal armor.

The size and type of cable used to run a particular electrical line depends both upon the length of the run, particular power requirements, and environmental and structural protection needed for the application. For example, cables used in places of public assembly are governed by NEC® 518 entitled Assembly Occupancies which requires the installation of armored or metal clad cable. Often cables are installed in these shared spaces with air handling equipment where certain organisms may proliferate. In addition the cable may be installed where the cable surface is exposed, as with lighting or heating and cooling elements, which may come in contact with microbes or fungi on their respective surfaces. In factories and processing plants where the atmospheric conditions may change considerably, protection through the use of polymeric coverings for such cable is necessary. Certain types of cables are installed in hospitals, nursing homes, medical centers and other health care facilities for use with various systems as well as other power and control applications. These cables must have a redundant grounding system pursuant to applicable section(s) of NEC® Article 517. These cables are referred to as health care facilities cable and may be installed in walls, ducts, and other environmental air-handling spaces. Along with other wiring methods, type AC and MC cable without an overall nonmetallic covering are permitted to be used in such air handling spaces pursuant to NEC® 300.22(C) (Other Space used for Environmental Air). However, cable used in healthcare facilities must have appropriate ratings when installed in such air-handling spaces which, in most buildings, is the area within ceilings or under raised floors.

When the metal armor requires corrosion protection, the metal is galvanized with a zinc coating at a desired thickness which must comply with the applicable standards test (e.g. Preece Test). Typically, galvanizing is a process in which the steel strip is either hot dipped or electroplated to apply zinc or other protective element onto the surface of the steel. The protective properties of zinc provide a corrosion resistant coating to the underlying steel. When the metal armor is made from aluminum, the aluminum does not require the added protection provided by galvanizing, but aluminum is generally more expensive than steel. Depending on where these various cable types are installed within a structure, the cable may be exposed to various microorganisms and may be susceptible to providing environments where certain fungi and microbes may proliferate. Present cable designs do not provide antimicrobial or antifungal properties for electrical cable. Thus, there is a need for electrical cable designed to overcome the deficiencies of present configurations.

### SUMMARY OF THE INVENTION

Exemplary embodiments of the present invention are directed to electrical cables. In an exemplary embodiment, an electrical cable includes a flexible metallic armor having an outer surface and defining an interior hollow area. A plurality of electrical conductors are disposed within the hollow area. A coating is disposed over the outer surface of the armor where the coating includes an antimicrobial and/or antifungal additive. The metallic armor may be metal, aluminum, electroplated steel or other metallic material. A visual indicator may be applied over the coating where the visual indicator is also treated with an antifungal and/or antimicrobial additive.

A method of manufacturing an exemplary electrical cable includes galvanizing a metal strip and applying a protective coating over the galvanized metal. An antimicrobial and/or antifungal material is added to the protective coating. The strip is dried and taken up on a coil which is then supplied to a profiling die which forms an arcuate member. The arcuate member is supplied to an interlocking tool which interlocks the edges of the arcuate members around a plurality of electrical conductors. A visual indicator may also be applied over the protective coating where the visual indicator is also treated with an antifungal and/or antimicrobial additive.

In an alternative method of manufacturing an exemplary electrical cable, an antimicrobial material is added to a coating mixture and applied over a metallic strip. The metallic strip may be aluminum, electroplated steel, etc., and the coating mixture may be a non-pigmented paint. The coated strip is supplied to a profiling die to form an arcuate member. The arcuate member is supplied to an interlocking tool which interlocks the edges of the arcuate members around a plurality of electrical conductors. A visual indicator may also be applied over the coating where the visual indicator is also treated with an antifungal and/or antimicrobial additive.

### BRIEF DESCRIPTION OF THE DRAWINGS

FIG. 1 is a side view of an exemplary electrical cable in accordance with the present invention.

FIG. 2A is a flow chart illustrating a process of making an exemplary galvanized metal cable in accordance with an embodiment of the present invention.

FIG. 2B is a flow chart illustrating a process of making an exemplary cable having an Aluminum, electroplated steel, etc., armor in accordance with an embodiment of the presented invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

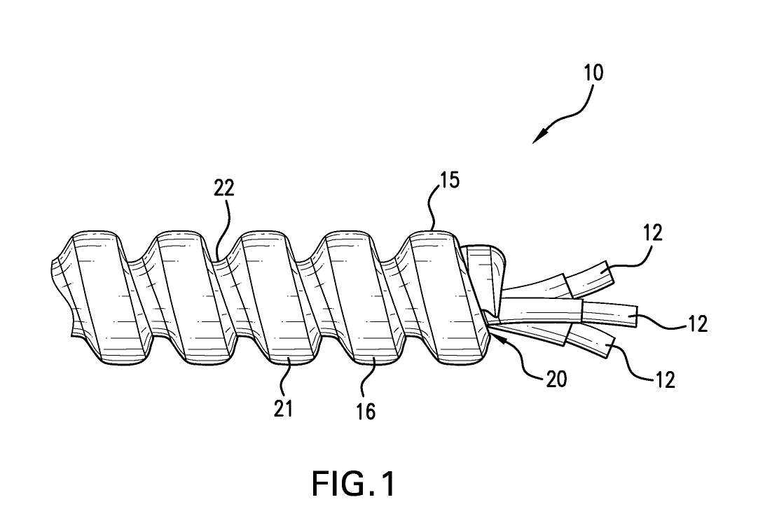

FIG. 1 is a side view of an exemplary cable 10 having an outer armor 15 defining an inner hollow area 20 within which electrical conductors 12 are disposed. Armor 15 may be made from a metallic material including, but not limited to galvanized steel, aluminum, electroplated steel, etc. To form armor 15, a strip of steel, aluminum, etc., is first contoured to produce crowns 21 and troughs 22. The strip is then helically wound and interlocked to form the outer armor 15 around the plurality of electrical conductors 12.

When armor 15 is made from steel, it undergoes a galvanizing process where a coating of zinc or other process material is applied to the steel to protect against corrosion before it is helically wound. A protective coating or other corrosion resistant surface treatment may also be applied over the surface of the zinc to enhance the corrosion resistance of cable 10. The protective coating or surface treatment is treated with an antimicrobial and or antifungal additive. As mentioned earlier, cable 10 may be installed in hospitals, nursing homes or other healthcare facilities as well as in other spaces and environmental air-handling areas of shared spaces within various structures. An antimicrobial and/or antifungal additive prevents the formation of, for example, MRSA (Methicillin-Resistant Staphylococcus Aureus) or Aspergillus Niger (commonly referred to as black mold), on cable 10 inhibiting the microbial from proliferating in a shared space environment. An exemplary antimicrobial additive is available from SteriTouch Ltd., and has the product name ST1100 (liquid form) or ST1006 (powder form). An exemplary antifungal additive is available from Rohm and Hass Ltd., and has the product name ROCIMA 200™. In addition, the antimicrobial additive available from SteriTouch also has antifungal properties and may also be used as both an antimicrobial and antifungal additive. These additives are introduced into the protective coating or surface treatment solution where the coating and the antimicrobial and/or antifungal additive bond to the galvanized metal. In some embodiments, the outer surface 16 of the armor 15 is painted. In particular, U.S. Pat. Nos. 5,350,885, 5,468,914, 5,557,071, RE38,345, 5,708,235, 6,825,418 incorporated herein by reference, disclose armored cables that are coded for easy visual identification. This coding indicates the characteristics of the cable, for example, number of conductors, type of insulation, type of cable, and/or type of application. This coding may take the form of various colors, patterns, etc, applied to the exterior surface of armor 15 using ink, dye, paint or other material. When a visual indicator is used on cable 10, the antimicrobial or antifungal material is added to the paint, dye, ink, etc., since the protective coating or surface treatment applied to the outer surface of armor 15 would be covered by the paint. Thus, the antimicrobial and/or antifungal additive would likewise be covered by the paint and rendered ineffective. By adding the antimicrobial and/or antifungal additive to the paint used as an indicator, the painted surfaces of armor 15 as well as the non-painted surfaces are similarly treated.

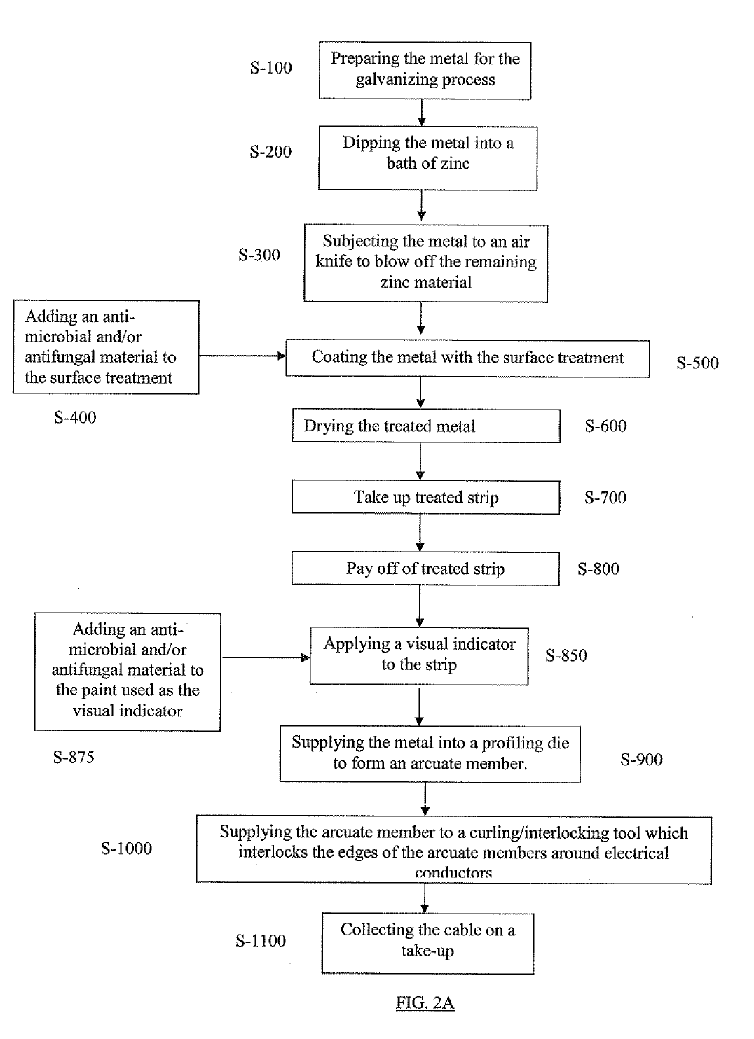

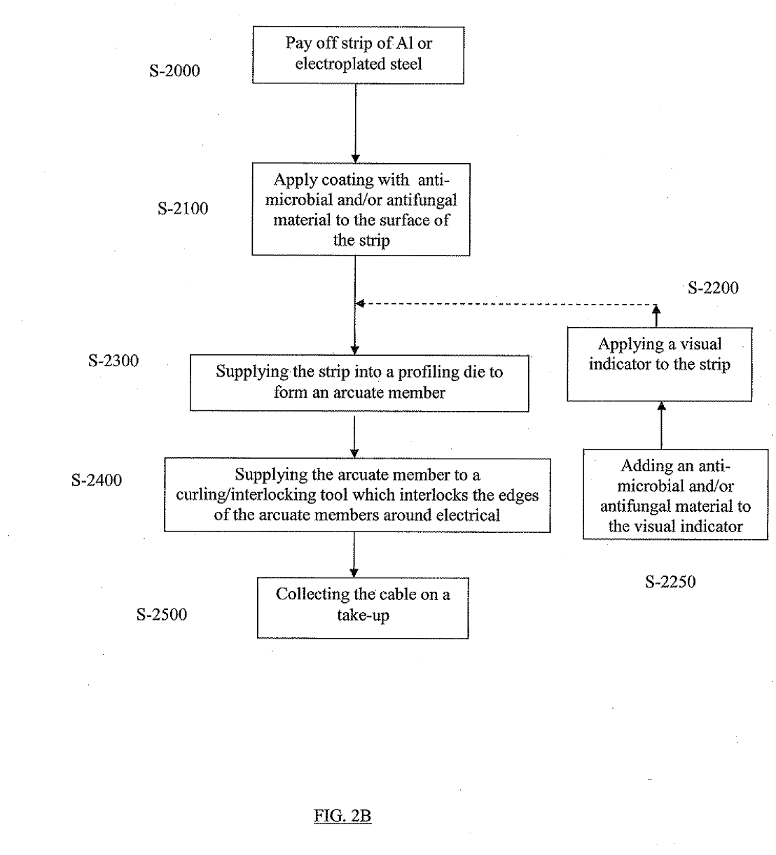

FIG. 2A is a flow chart illustrating an exemplary method of treating strip steel used to manufacture cable 10 shown in FIG. 1 which includes adding an antimicrobial and/or antifungal material in the surface protection processing step. The metal used for outer armor 15 is considered a ferrous metal which is susceptible to corrosion in the presence of moisture. As such, various protective coatings may be used to prevent atmospheric corrosion. One typical process is a galvanized coating, which can be applied by a hot dip or electroplate process. In a hot dip process, the metal is prepared using various steps including washing, rinsing, etc, at step S-100. At step S-200, the steel passes through a bath of molten zinc which forms an intermetallic compound at the interface of the zinc and the metal together with a relatively pure zinc coating at the surface of armor 15 of cable 10. After hot dipping, the coated metal is subject to an air knife at step S-300 in which high pressure air guns blow-off the excess zinc material. The antimicrobial material is added to a surface treatment at step S-400. By way of example, various surface treatments may be applied over the galvanized metal such as hexavalent chromate, magnesium, trivalent chromium, or other passivation agents. As noted above, an exemplary antimicrobial additive is available from SteriTouch Ltd., and has the product name ST1100 and ST1006 and added in liquid or powder form respectively at about 0.4% by volume. At step S-500, the protective coating or surface treatment and antimicrobial and/or antifungal material are applied over the surface of the zinc coated metal. The metal is dried at step S-600 and supplied to a take-up at step S-700. In the event that the cable is to be painted to indicate the type of conductors housed in the cable and/or the particular intended use for the cable, the treated strip is taken from the pay-off at step S-800 and a visual indicator is applied to a portion of the surface of the strip at step S-850. The antimicrobial and or anti fungal additive would also be included in the paint at step S-875 since part of the surface of the treated cable would be covered by the visual indicator. The strip is supplied to a profiling die to form an arcuate member at step S-900. The arcuate members are supplied to a curling/interlocking tool which interlocks the edges of the arcuate members around electrical conductors at step S-1000. The cable is then collected on a take-up at step S-1100.

When armor 15 of FIG. 1 is made from aluminum, electroplated steel, or similar material the strip is also contoured to produce crowns 21 and troughs 22 and helically wound and interlocked to form the outer armor 15 around the plurality of electrical conductors 12 similar to the armor made from steel. However, because armor 15 is made from aluminum or electroplated steel, the strips may not undergo the hot dip corrosion protection process described with reference to FIG. 2A. Thus, the antimicrobial and/or antifungal additive cannot be applied through this process. Accordingly, a paint (e.g. clear coat without pigmentation) is applied to the surface of the aluminum or electroplated strip used to form armor 15. This paint is treated with the antimicrobial and or antifungal additive as referenced above. The paint adheres to the surface 16 and provides the armor made from aluminum or electroplated steel with an antimicrobial and antifungal additive that prevents the formation of, for example, MRSA (Methicillin-Resistant Staphylococcus Aureus) or Aspergillus Niger (commonly referred to as black mold), inhibiting the proliferating or these microorganisms on the surface of armor 15. Alternatively, the antimicrobial and/or antifungal additive may be included in the electroplating process obviating the need to apply these additives using a clear coat paint. In addition, cable 10 made from aluminum or electroplated steel may be coded for easy visual identification as described in U.S. Pat. Nos. 5,350,885, 5,468,914, 5,557,071, RE38,345, 5,708,235, 6,825,418 incorporated herein by reference. Similar to the coding description above with reference to the process of FIG. 2A, the visual indicia is applied to the outer surface 16 of the aluminum or electroplated steel armor 15. Since the visual indicia overlays portions of the clear coat paint applied to the outer surface of the aluminum or electroplated armor, the material used as the visual indicia is also treated with the antimicrobial and/or antifungal additive otherwise the portions of the surface of the armor covered with the visual indicia would not exhibit the antimicrobial and/or antifungal properties. Alternatively, the material used as the visual indicia is applied to the outer surface of aluminum armor without the antimicrobial and or antifungal additive and a clear coat of paint (i.e. non-pigmented) treated with the antimicrobial and or antifungal additive is applied over the visual indicia since the visual indicia is not always applied to the entire surface of armor 15. If a treated clear coat of paint is not applied to the cable, then those portions of the cable that were not painted would not be treated with the antimicrobial and or antifungal additive and micro-organisms could manifest themselves thereon.

FIG. 2B is a flow chart illustrating an exemplary method of forming and treating armor 15 when the armor is made from aluminum, electroplated steel or other metallic material not otherwise exposed to corrosion treatment as illustrated in FIG. 2A. The aluminum or electroplated steel strip is supplied from a pay-off at step S-2000. A coating, for example a clear coat (e.g. without pigmentation) of paint, is applied to the outer surface of the aluminum or electroplated steel strip at step S-2100. The clear coat paint is treated with the antimicrobial and/or antifungal additive as referenced above. The paint adheres to the outer surface of the aluminum or electroplated steel and provides the strip with an antimicrobial and antifungal additive that prevents the formation of, for example, MRSA (Methicillin-Resistant Staphylococcus Aureus) or Aspergillus Niger (commonly referred to as black mold), inhibiting the proliferating or these microorganisms on the formed cable 10. In the event that the cable 10 (when formed through this process) includes a visual indictor to indicate the type of conductors housed in the cable and/or the particular intended use for the cable, the visual indicator is applied to a portion of the surface of the aluminum or electroplated strip at step S-2200. The antimicrobial and/or antifungal additive is added to the material used as the visual indicator (e.g. paint) at step S-2250 before the visual indicator is applied to the surface of the aluminum or electroplated steel strip. This is done since portions of the surface applied with the clear coat paint from step S-2100 would be covered by the application of the visual indicator at step S-2200. The aluminum or electroplated steel strip is supplied to a profiling die to form an arcuate member at step S-2300. The aluminum or electroplated steel arcuate members are supplied to a curling/interlocking tool which interlocks the edges of the arcuate members around electrical conductors at step S-2400. The cable is then collected on a take-up at step S-2500. In this manner, a cable having an aluminum or electroplated steel armor is treated with an antimicrobial and/or an antifungal additive inhibiting the proliferating or these microorganisms on cable 10 when installed within a building or structure.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An electrical cable comprising:
a flexible metallic armor having an outer surface and defining an interior hollow area;
a plurality of electrical conductors disposed within said hollow area; and
a coating disposed over said outer surface of said armor, said coating including an antimicrobial additive such that said coating and the antimicrobial additive bond to the outer surface of said armor.

2. The electrical metal cable of claim 1 further comprising a surface treatment disposed between said outer surface of said armor and said coating.

3. The electrical metal cable of claim 2 wherein said surface treatment comprises zinc.

4. The electrical metal cable of claim 1 wherein said coating comprises chromate.

5. The electrical metal cable of claim 1 wherein said flexible metallic armor comprises a metal strip helically wound with interlocking edges.

6. The electrical metal cable of claim 1 wherein said flexible metallic armor comprises an aluminum strip helically wound with interlocking edges.

7. The electrical metal cable of claim 6 wherein said coating comprises paint.

8. The electrical metal cable of claim 1 wherein said flexible metallic armor comprises an electroplated steel strip helically wound with interlocking edges.

9. The electrical metal cable of claim 8 wherein said coating comprises paint.

10. The electrical cable of claim 1 further including a visual indicator applied to at least a portion of the outer surface of said metallic armor, said visual indicator treated with an antimicrobial additive.

11. The electrical cable of claim 1 further including a visual indicator applied to at least a portion of the outer surface of said metallic armor, said visual indicator treated with an antifungal additive.

12. The electrical cable of claim 1 wherein the coating further comprises an antifungal additive.

13. An electrical cable comprising:
a flexible metallic armor having an outer surface and defining an interior hollow area;
a plurality of electrical conductors disposed within said hollow area; and
a coating disposed over said outer surface of said armor, said coating treated with an antifungal additive such that said protective coating and the antifungal additive bond to the outer surface of said armor.

14. The electrical metal cable of claim 13 further comprising a surface treatment disposed between said outer surface of said armor and said coating.

15. The electrical metal cable of claim 14 wherein said surface treatment comprises zinc.

16. The electrical metal cable of claim 13 wherein said coating comprises chromate.

17. The electrical metal cable of claim 13 wherein said flexible metallic armor comprises a metal strip helically wound with interlocking edges.

18. The electrical metal cable of claim 13 wherein said flexible metallic armor comprises an aluminum strip helically wound with interlocking edges.

19. The electrical metal cable of claim 18 wherein said coating comprises paint.

20. The electrical metal cable of claim 13 wherein said flexible metallic armor comprises an electroplated steel strip helically wound with interlocking edges.

21. The electrical metal cable of claim 20 wherein said coating comprises paint.

22. The electrical cable of claim 13 further including a visual indicator applied to at least a portion of the outer surface of said metallic armor, said visual indicator treated with an antimicrobial additive.

23. The electrical cable of claim 13 further including a visual indicator applied to at least a portion of the outer surface of said metallic armor, said visual indicator treated with an antifungal additive.

24. The electrical cable of claim 13 wherein the coating further comprises an antimicrobial additive.

25. A method of manufacturing an electrical cable comprising:
galvanizing a metal strip with a zinc coating;
adding an antimicrobial material to a protective coating;
covering said zinc coated strip with said protective coating;
drying said protective covered strip;
supplying the protective covered strip into a profiling die to form an arcuate member; and
supplying the arcuate members to a interlocking tool which interlocks the edges of the arcuate members around a plurality of electrical conductors.

26. A method of manufacturing an electrical cable comprising:
galvanizing a metal strip with a zinc coating;
adding an antifungal material to a protective coating;
covering said zinc coated strip with said protective coating;
drying said protective covered strip;
supplying the protective covered strip into a profiling die to form an arcuate member; and
supplying the arcuate members to an interlocking tool which interlocks the edges of the arcuate members around a plurality of electrical conductors.

27. A method of manufacturing an electrical cable comprising:
adding an antimicrobial material to a coating mixture;
applying the coating mixture to a metallic strip;
supplying the coated strip into a profiling die to form an arcuate member; and
supplying the arcuate members to an interlocking tool which interlocks the edges of the arcuate members around a plurality of electrical conductors.

28. The method of manufacturing an electrical cable of claim 27 further comprising applying a visual indicator to at least a portion of the coated strip, said visual indicator treated with an antimicrobial additive.

29. The method of manufacturing an electrical cable of claim 27 further comprising applying a visual indicator to at least a portion of the coated strip, said visual indicator treated with an antifungal additive.

30. The method of manufacturing an electrical cable of claim 27 wherein said metallic strip is aluminum.

31. The method of manufacturing an electrical cable of claim 27 wherein said metallic strip is electroplated steel.

32. The method of manufacturing an electrical cable of claim 27 wherein said coating is paint.

33. A method of manufacturing an electrical cable comprising:
adding an antifungal material to a coating mixture;
applying the coating mixture to a metallic strip;
supplying the coated strip into a profiling die to form an arcuate member; and
supplying the arcuate members to an interlocking tool which interlocks the edges of the arcuate members around a plurality of electrical conductors.

34. The method of manufacturing an electrical cable of claim 33 further comprising applying a visual indicator to at least a portion of the coated strip, said visual indicator treated with an antimicrobial additive.

35. The method of manufacturing an electrical cable of claim 33 further comprising applying a visual indicator to at least a portion of the coated strip, said visual indicator treated with an antifungal additive.

36. The method of manufacturing an electrical cable of claim 33 wherein said metallic strip is aluminum.

37. The method of manufacturing an electrical cable of claim 33 wherein said metallic strip is electroplated steel.

38. The method of manufacturing an electrical cable of claim 33 wherein said coating is paint.
